(19) United States
(12) Patent Application Publication
(10) Pub. No.: US 2026/0032006 A1
(43) Pub. Date: Jan. 29, 2026

(54) CROWDSOURCING IMAGE ANNOTATION USING GRID IMAGE USER AUTHENTICATION SYSTEMS

(71) Applicant: Volvo Car Corporation, Göteborg (SE)

(72) Inventors: Zhennan Fei, Göteborg (SE); Ali Nouri, Göteborg (SE)

(21) Appl. No.: 18/787,243

(22) Filed: Jul. 29, 2024

(51) Int. Cl. H04L 9/32; B60W 50/14; G06T 7/11; G06V 20/56

(52) U.S. Cl. CPC H04L 9/3271; B60W 50/14; G06T 7/11; G06V 20/588; G06V 2201/07

(57) ABSTRACT

Techniques for automating image annotation for machine model updating are described. An example, computer implemented method comprises collecting images processed by an object detection model and associated with a detection error by the object detection model, wherein the object detection model is configured to detect respective objects in the images having a defined criterion. The method further comprises converting the images into grid images comprising a plurality of cells, providing the grid images to an authentication system that employs the grid images in association with authenticating users based on reception of user input selecting respective cells of the grid images depicting an object having the defined criterion, and receiving the grid images from the authentication system with annotation data associated therewith generated based on the user input, the annotation data identifying the respective cells of the grid images depicting the object having the defined criterion.

### TECHNICAL FIELD

The disclosed subject matter relates to generating image annotations for machine learning model training and updating, and more particularly to a crowdsourcing framework for image annotation using grid image user authentication systems.

### BACKGROUND

Image data annotation for object detection involves labeling images with bounding boxes and class labels to indicate the presence and location of objects. While this is a crucial step for training and updating object detection models, annotating large datasets is time-consuming and requires significant manual effort, which can be costly and slow. For example, annotating frames in vision and lidar systems that employ an object detection model to detect presence and location of defined object classes in video frames typically involves manually reviewing and annotating a massive amount of frames. This task is usually outsourced to external suppliers by sending batches of frames for annotation back and forth in association with regularly and/or continuously updating the object detection model to improve its accuracy and/or specificity for a given local deployment environment. Such a centralized and time-consuming way of image data annotation is not compatible with the popular and rapid federated learning approaches designed to improve the scalability of continued model development and optimization.

The above-described background relating to issues associated with image data annotation for object detection is intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products are described that facilitate crowdsourcing image annotation using grid image user authentication systems.

As alluded to above, techniques for automating image data annotation for training object detection models using a federated learning approach are desirable, and various embodiments are described herein to this end and/or other ends.

According to an embodiment, a system can comprise a memory that stores computer-executable components, and a processor that executes the computer-executable components stored in the memory. The computer-executable components include a collection component that collects images processed by an object detection model and associated with a detection error by the object detection model, wherein the object detection model is configured to detect respective objects in the images having a defined criterion. The computer-executable components further include an image division component that converts the images into grid images comprising a plurality of cells, and an outsourcing annotation component that provides the grid images to an authentication system that employs the grid images in association with authenticating users based on reception of user input selecting respective cells of the grid images depicting an object having the defined criterion, and receives the grid images from the authentication system with annotation data associated therewith generated based on the user input, the annotation data identifying the respective cells of the grid images depicting the object having the defined criterion.

In various embodiments, the computer-executable components further comprise a training component that employs the annotation data as ground truth information in association with training the object detection model to detect the respective objects having the defined criterion in the images and additional images with a reduction of the detection error.

In one or more example implementations, the images comprise vehicle images captured via one or more cameras integrated on or within a vehicle. For example, the vehicle images can depict respective external environments of the vehicle and wherein the defined criterion comprises a defined object type classification, such as a lane marker classification. In accordance with this example, an advanced driver assistance system of the vehicle (e.g., an autonomous driving system, a semi-autonomous driving system, or the like) can employ the object detection model to detect lane markers relative to the vehicle and control various driving operations of the vehicle accordingly.

In some embodiments, elements described in connection with the disclosed systems can be embodied in different forms such as a computer-implemented method, a computer program product, or another form.

### BRIEF DESCRIPTION OF DRAWINGS

FIG. 1 illustrates a block diagram of an exemplary system that facilitates crowdsourcing image annotation using grid image user authentication systems, in accordance with one or more embodiments described herein.

FIG. 2 illustrates a signaling diagram illustrating an example process for crowdsourcing image annotation using grid image user authentication systems, in accordance with one or more embodiments described herein.

FIG. 3 illustrates example input and output data capable of being generated by an object detection model configured to detect lane markings in accordance with one or more embodiments described herein.

FIG. 4 illustrates example grid images in accordance with one or more embodiments described herein.

FIGS. 5A and 5B illustrate usage of a grid image user authentication system to annotate image data for training/updating an object detection model, in accordance with one or more embodiments described herein.

FIG. 6 illustrates a block diagram of an example model deployment system in accordance with one or more embodiments described herein.

FIG. 7 illustrates a block diagram of an example federated learning system in accordance with one or more embodiments described herein.

FIG. 8 illustrates a block diagram of an authentication system in accordance with one or more embodiments described herein.

FIG. 9 illustrates a block flow diagram of an example, non-limiting computer-implemented method for crowdsourcing image annotation using grid image user authentication systems, in accordance with one or more embodiments described herein.

FIG. 10 illustrates a block flow diagram of another example, non-limiting computer-implemented method for crowdsourcing image annotation using grid image user authentication systems, in accordance with one or more embodiments described herein.

FIG. 11 is an example, non-limiting computing environment in which one or more embodiments described herein can be implemented.

FIG. 12 is an example, non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

The disclosed subject matter is directed to systems, devices, computer-implemented methods, apparatuses and/or computer program products that facilitate crowdsourcing image annotation using grid image user authentication systems. In this regard, advancements in machine learning techniques (e.g., deep neural networks) have led to the development of intelligent models capable of performing various visual analysis tasks with high performance accuracy and specificity. For example, such visual analysis tasks include image classification (e.g., assigning a label to an entire image), object detection (e.g., identifying and localizing objects within an image), semantic segmentation, instance segmentation, image generation and enhancement, image style transfer, facial recognition, medical image analysis, and others.

These types of machine models have been used across various domains/industries to drive innovation and improve efficiency and accuracy of operations. For example, in the automotive industry, object detection models that automatically detect lane markings, pedestrians, other vehicles, road signs, traffic signals, obstacles and the like, from image data captured of the same by an onboard camera, have been used to enable autonomous vehicles and other advanced driver assistance systems (e.g. enhancing safety features like collision avoidance, lane departure warnings, and parking assistance). In another example, object detection models have been used in the healthcare industry to identify and localize anatomical structures and features in medical images and live images captured during surgery. In another example, object detection models are used in various augmented reality and virtual reality systems to identify and localize objects appearing in real and virtual environments in association with performing various automated responses.

These object detection models typically use supervised machine learning techniques, such as deep neural networks, which rely on gathered annotated image data used as ground truth exemplars for training, validating and testing the machine leaning models. However, the annotated image data is typically generated via manual review of the images in association with manually labeling/defining respective objects and their locations in the training images, a slow and costly process that hinders the continued updating and optimization of such models over time. In this regard, to improve these models continuously over time, it is necessary to retrain and update the models to improve their performance based on feedback regarding model errors or failure modes observed in actual deployment environments (e.g., post initial training and development). This can involve retraining the model to improve its performance on image variants that were encountered in the deployment environment for which the model's performance was inaccurate. Such image variants may correspond to new image variants that were encountered in the deployment environment and likely underrepresented in the initial training dataset. To facilitate this end, these image variants must be identified, obtained and annotated with ground truth labels prior to usage thereof for continued model training.

The disclosed subject matter addresses this annotation problem by using grid image authentication systems and a crowdsourcing framework to facilitate obtaining annotated training image data for training and updating object detection models. In this regard, as used herein, a grid image authentication system is used to refer to an authentication system that authenticates a user based on presenting the user with a grid image and receiving user input selecting respective cells of the grid image known to contain image data satisfying one or more defined criteria, such as containing a particular type of object (e.g., an animal, traffic lights, pedestrians, traffic signs, lane markings, etc.). When the correct cells are chosen, the user is authenticated. Typically, such grid image authentication techniques are used by computing systems to test whether a user is a human or a bot, a technique or test referred to as a CAPTCHA (e.g., Completely Automated Public Turing test to tell Computers and Humans Apart). CAPTCHAs are designed to protect websites from spam, abuse, and automated attacks by ensuring that only humans can perform certain actions, such as submitting forms or creating accounts. In this regard, an image-based CAPTCHA refers to a test that requires users to select all cells of a grid image that match certain criterion (e.g., all cells containing traffic lights, lane markings, cars, storefronts, etc.).

To this end, the disclosed techniques use image-based CAPTCHAs to obtain annotation data for images as converted to grid images, the annotation data identifying respective locations (corresponding to respective cells of the grid images) within the images comprising an object (or portion thereof) that matches certain criterion. In various embodiments, the images include or correspond to images processed by an object detection model which resulted in a detection error by the object detection model, wherein the object detection model is configured to detect respective objects in the images that match the certain criterion. The detection error can include or correspond to an error measure that indicates the object detection model possibly incorrectly or inaccurately detected one or more objects in the images that match the certain criterion. For example, as applied to an object detection model employed by an autonomous driving system of a vehicle configured to detect lane markings in video frames captured by a camera of the vehicle, the images can include or correspond to frames for which lane markings are missed or detected with low confidence by the object detection model. In accordance with this example, these frames attributed to detection errors by the object detection model employed by the vehicle can be collected for annotation, and the annotated frames can be used to further train/update the objected detection model to improve its performance.

In various embodiments, the images collected for annotation (e.g., those attributed to objects missed by the object detection model or detected with low confidence) are converted to grid images comprising a plurality of cells. The grid images are then used by one or more authentication systems to authenticate users in accordance with image-based CAPTCHA. For example, one or more authentication systems can include or correspond to authentication systems employed by various websites, web-applications, mobile applications and the like, to prove that their users are not robots. In this regard, in accordance with image-based CAPTCHA, the authentication system can be configured to present a grid image to a user in association with prompting the user to select respective cells of the grid image depicting the object that matches the defined criterion, such as lane markings in furtherance to the example above. The authentication system, can authenticate the user based on reception of user input selecting one or more known cells in the grid image known to depict the object that matches the defined criterion. The authentication system can further generate annotation data identifying any additional cells depicting the object based on reception of additional user input selecting the additional cells.

To facilitate this end, in some embodiments, the images that are collected for annotation can include images respectively comprising one or more first regions associated with a first confidence score indicative of a high level of confidence that the one or more first regions depict the object as detected by the object detection model, and one or more second regions associated with a second confidence score indicative of a lower level of confidence relative to the high level of confidence, that the one or more second regions depict the object as detected by the object detection model. With these embodiments, the authentication system can employ the grid images in association with authenticating the users based on reception of the user input selecting one or more first cells of the grid images comprising the one or more first regions. The authentication system can further generate the annotation data based on reception of the user input selecting one or more second cells of the grid images excluding the one or more first regions. In other words, in accordance with the lane markings example, the cells representing the detected lane markings by the object detection model (with high confidence) are used to determine if the selection from the user is correct for authentication, while the parts that are not detected or detected with low confidence by the object detection model are not for authentication but meant for annotation.

In some embodiments, the same grid image can be used for multiple CAPTCHA tests and by multiple authentication systems and/or websites. Annotation data gathered for the same grid image can further be aggregated in a crowd-sourced manner. Annotation data gathered for a plurality of images for which a particular object detection model is configured to process as input can further be used to regularly or continuously train and/or update the object detection model over time. In other words, the annotation data can be used as ground truth information in association with training the object detection model to detect the respective objects that match the defined criterion in the images and additional images with improved accuracy and/or specificity.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

The terms “algorithm” and “model” are used herein interchangeably unless context warrants particular distinction amongst the terms. The terms “artificial intelligence (AI) model” and “machine learning (ML) model” are used herein interchangeably unless context warrants particular distinction amongst the terms. Reference to an AI or ML model herein can include any type of AI or ML model, including (but not limited to): deep learning models, neural network models, deep neural network models (DNNs), convolutional neural network models (CNNs), generative adversarial neural network models (GANs) and the like. An AI or ML model can include supervised learning models, unsupervised learning models, semi-supervised learning models, combinations thereof, and models employing other types of ML learning techniques. An AI or ML model can include a single model or a group of two or more models (e.g., an enable model or the like).

It will be understood that when an element is referred to as being “coupled” to another element (and/or “connected” to another element or variations thereof), it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments described herein.

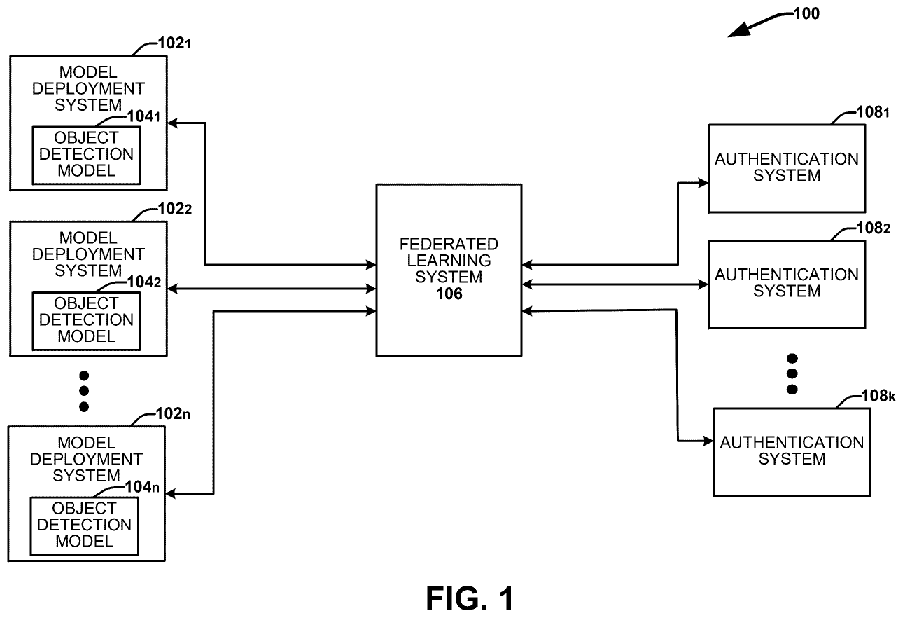

Turning now to the drawings, FIG. 1 illustrates a block diagram of an exemplary system 100 that facilitates crowdsourcing image annotation using grid image user authentication systems, in accordance with one or more embodiments described herein. System 100 comprises a plurality of model deployment systems 102₁₋ₙ, federated learning system 106 and a plurality of authentication systems 108₁₋ₖ.

The model deployment systems 102₁₋ₙ correspond to different systems that respectively employ object detection models 104₁₋ₙ to facilitate performing one or more operations of the respective model deployment systems 102₁₋ₙ. In various embodiments, the object detection models 104₁₋ₙ respectively correspond to different local versions of the same object detection model and the model deployment systems 102₁₋ₙ can respectively correspond to the same or similar type of model deployment system. The object detection model (e.g., each of object detection models 104₁₋ₙ) can include or correspond to a machine learning model (e.g., a neural network model and/or another type of machine learning model) that has been trained to detect and localize an object that matches defined criterion as depicted in input image data.

The type of the model deployment systems 102₁₋ₙ, the particular object defined criterion for which the object detection models 104₁₋ₙ are trained to detect, and the particular usage application of the object detection model output by the model deployments 102₁₋ₙ can vary. Likewise, the number n of different model deployment systems 102₁₋ₙ and their respective object detection models 104₁₋ₙ can vary.

In one or more embodiments, the model deployment systems 102₁₋ₙ include or correspond to different vehicles. For example, the different vehicles can correspond to any type of transportation vehicle. For instance, the different vehicles can include or correspond to any type of motor vehicle (e.g., a car, a truck, a van, a sport utility vehicle (SUV), etc.). In some implementations, the different vehicles can include or correspond to other types of vehicles, such as boats, planes, drones, trains, and so on. In some embodiments, the different vehicles can include or correspond to an autonomous vehicle or a semi-autonomous vehicle. An autonomous vehicle, also known as a self-driving car or driverless car, is a vehicle capable of navigating and operating without direct human input using a combination of sensors, cameras, radar, lidar, GPS, and advanced software algorithms to perceive their environment, make decisions, and control their movement. The Society of Automotive Engineers (SAE) has defined six levels of automation for vehicles, ranging from Level 0 (no automation) to Level 5 (full automation). Level 5 autonomy refers to vehicles that can operate in all conditions without any human intervention, while lower levels of autonomy require varying degrees of human input or supervision. In this regard, in some embodiments, the different vehicles can operate in different modes including an autonomous driving mode (e.g., corresponding to Level 5), a no automation mode (e.g., corresponding to Level 0), and a semi-autonomous driving mode (e.g., corresponding to any level between Level 0 and Level 5).

In accordance with embodiments in which the model deployment systems 102₁₋ₙ correspond to vehicles, the object detection models 104₁₋ₙ can include or correspond to an object detection model trained to detect and localize an object as depicted in image data captured via one or more cameras located on or within the vehicles. The vehicles can further be configured to employ the output of the object detection models 104₁₋ₙ for various applications, such as autonomous driving applications, advanced driver assistance system (ADAS) applications, parking assistance applications, traffic monitoring and management applications, and others.

For example, in some implementations, the object detection models 104₁₋ₙ can be configured to detect lane markings as depicted in image data (e.g., still images and/or video frames) captured of the external environment of the corresponding vehicle via one or more cameras of the vehicle. The term lane marking is used herein to refer to a visual indicator painted or applied on road surfaces to guide and regulate the flow of traffic. They play a crucial role in road safety and traffic management by delineating lanes, indicating where vehicles should travel, and providing instructions or warnings to drivers. There are many different types of lane markings which can vary across different geographical locations. Some example lane markings include (but are not limited to): center line markings, lane divider markings, edge line markings, turn lane markings, crosswalks, stop lines, high-occupancy vehicle (HOV) lane markings, bike lane markings, chevron markings. With these implementations, the vehicles can be configured to employ the model detected lane markers to automatically control driving operations of the vehicles (e.g., controlling steering the vehicle to maintain the vehicles in their lanes) and/or to notify the driver if they are unintentionally drifting out of their lane. In this regard, lane markings are critical for the operations of ADAS and autonomous driving systems. Detecting lane markers with high confidence by the lane marking detection model is crucial for the safety of autonomous driving. Inaccurate or missing detection can cause steering problems for an autonomous vehicle, thus having high risk of leaving its lane and potentially leading to incidents or collisions with other road users.

In another embodiment in which the model deployment systems 102₁₋ₙ correspond to vehicles, the object detection models 104₁₋ₙ can be configured/trained to detect a pedestrian or a particular type of vulnerable road user (VRU) as depicted in image data captured of the external environment of the corresponding vehicle. The term vulnerable road user (VRU) is used to refer an entity who is at a higher risk of injury or fatality in traffic accidents due to their lack of protection compared to motor vehicle occupants. A VRU can include many types of less protected traffic participants, such as pedestrians, cyclists, equestrians (e.g., horseback riders, horse-drawn carriages, etc.), motorcyclists, and various forms of motorized and non-motorized vehicles with occupants/divers exposed to the external environment (e.g., operated two-wheelers, operated four-wheelers, operated golf-carts, operated motorized scooters, operated segways/ninebots, and the like). In accordance with this example, the vehicles can be configured to use information regarding a detected VRU to control driving operations of the vehicle so as to avoid collisions between the vehicle and the VRU, and/or to notify the driver of the vehicle regarding the detected VRU and/or other vehicles regarding the detected VRU so as to increase driver awareness regarding VRUs.

Still in other embodiments in which the model deployment systems 102₁₋ₙ correspond to vehicles, the object detection models 104₁₋ₙ can include or correspond to models configured/trained to detect and localize various other types of objects that appear in image data captured of the external and/or internal environments of the vehicles (e.g., various types of obstacles on the road, animals, traffic sign and other traffic signals, objects). In this regard, it should be appreciated that the usage examples provided above for embodiments in which the model deployment systems 102₁₋ₙ correspond to vehicles are merely exemplary. It should be appreciated that object detection in modern vehicles is a fundamental technology that underpins a wide range of applications aimed at improving safety, automation, and overall driving experience. In this regard, the particular type or criterion of the object that the object detection models 104₁₋ₙ are configured to detect in image data captured via one or more cameras of the vehicles and the particular usage application of the object detection models 104₁₋ₙ by the vehicles can vary.

In other embodiments, the model deployment systems 102₁₋ₙ can respectively include or correspond to augmented reality systems that use object detection for various applications. For example, in some embodiments, the augmented reality systems can employ object detection models 104₁₋ₙ configured to detect and localize a wide range of different types of objects depicted in image data captured of a current environment of a user being viewed through a transparent display. The augmented reality systems can further employ the output of the models to facilitate generating relevant auxiliary content (e.g., based on the objects detected or not detected), spatially aligning the auxiliary content with the detected objects, and various other responses.

Various other types of model deployment systems that can employ object detection models 104₁₋ₙ configured to detect and localize a wide range of different types of objects depicted in image data are envisioned. Depending on the usage scenario and the type of the model deployment systems 102₁₋ₙ, the image data may be captured via one or more cameras of the model deployment systems 102₁₋ₙ and/or received by the model deployment systems from another system or device.

Regardless of the type of the model deployment systems 102₁₋ₙ and the type of the object detection models 104₁₋ₙ, in accordance with system 100 the model deployment systems 102₁₋ₙ are configured to apply their respective object detection models 104₁₋ₙ to input image data (e.g., comprising one or more images) to generate output data. In accordance with the disclosed techniques, the output data can identity whether an input image comprises one or more objects that match one or more defined object criteria, such as being a particular object type, being a particular object type and having a particular color, size, shape, or the like. The output data can also identify or indicate the location/position of a matching object in the input image, the contour or outline of the object, and/or the dimensions of the object. For instance, as applied to lane markings, the output data can include or correspond to mark-up image data that comprises mark-up data applied to the input image that marks respective locations in the input image where lane markings were detected by the object detection model. In some implementations, the mark-up data can alternatively trace the counters of the lane markings that were detected by the object detection model.

In accordance with various embodiments, the federating learning system 106 can be configured to collect or otherwise receive images processed by the respective object detection models 104₁₋ₙ at the model deployment systems 102₁₋ₙ that are attributed to (or potentially attributed to) detection errors by the object detection models 104₁₋ₙ. For example, in embodiments in which the respective model deployment systems 102₁₋ₙ correspond to vehicles and the respective object detection models 104₁₋ₙ correspond to lane marking detection models configured/trained to detect lane markings in video frames captured by respective cameras of the vehicles, the images collected by the federated learning system 106 can include or correspond to frames for which lane markings are missed or detected with low confidence by the lane marking detection models. In this regard, the federated learning system 106 can collect or otherwise receive runtime images attributed to poor object detection results by the object detection models 104₁₋ₙ.

The federated learning system 106 can further facilitate obtaining manual (e.g., user provided) annotation data for these images that indicates respective positions in the images depicting an object that matches the particular criterion for which the respective object detection models 104₁₋ₙ are configured to detect. To facilitate this end, the federated learning system 106 can convert the collected images into grid images and provide the grid images to one or more authentication systems 108₁₋ₖ that employ the grid images for user authentication in accordance with image-based CAPTCHA. In this regard, the one or more authentication systems 108₁₋ₖ can include or correspond to authentication systems employed by various websites, web-applications, mobile applications, or the like, to prove that their users are not robots. The user input received for the image-based CAPTCHA by the one or more authentication systems 108₁₋ₖ is further provided back to the federated learning system 106 and employed as annotation data for the images corresponding to the grid images. The federated learning system 106 can further facilitate updating (e.g., retraining) the respective object detection models 104₁₋ₙ to improve their performance accuracy using these images as training images and their corresponding annotation data as the ground truth exemplars.

Thus, the federated learning system 106 can include or correspond to a centralized (e.g., cloud-based) computing system that facilitates collecting images for annotation from a plurality of different model deployment systems 102₁₋ₙ, provides the images to the one or more authentication systems 108₁₋ₖ, and receives the images with annotation data applied thereto by the respective authentication systems 108₁₋ₖ. The federated learning system 106, the one or more model deployment systems 102₁₋ₙ, and the one or more authentication systems 108₁₋ₖ can be communicatively coupled to one another via any suitable wired or wireless communication framework. In some embodiments, the federated learning system 106 can be configured to provide the annotated images back to the respective model deployment systems 102₁₋ₙ, which in turn can employ the annotated images to retrain and update their respective objected detection models 104₁₋ₙ locally over time. With these embodiments, different updates (e.g., neural network parameter/hyperparameter modifications) to respective versions of the object detection models 104₁₋ₙ as deployed at the respective model deployment systems 102₁₋ₙ can be generated locally in an accordance with a federated learning framework. These updates can further be provided by the respective model deployment systems 102₁₋ₙ back to the federated learning system 106, which in turn can aggregate the updates (e.g., using federated averaging or another federated learning technique) to create a global version of the respective object detection models 104₁₋ₙ that accounts for all or some of the local updates. The federated learning system 106 can further provide the global version of the object detection model back to the respective model deployment systems 102₁₋ₙ.

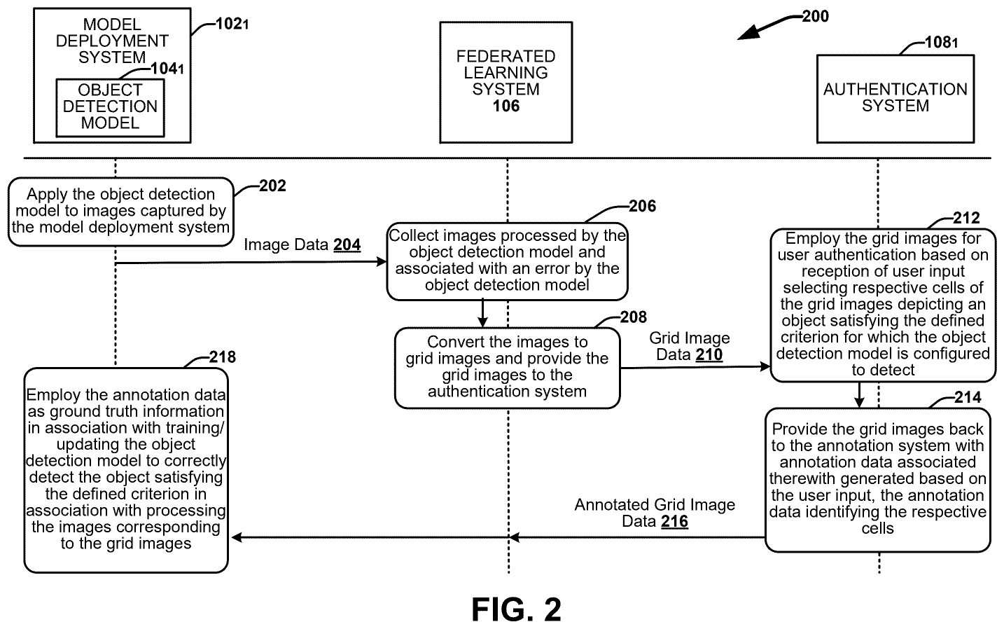

FIG. 2 illustrates a signaling diagram illustrating an example process 200 for crowdsourcing image annotation using grid image user authentication systems, in accordance with one or more embodiments described herein. With reference to FIG. 2 in view of FIG. 1, process 200 is exemplified from the perspectives of a single model deployment system (e.g., model deployment system 102₁) and a single authentication system (e.g., authentic system 108₁). It should be appreciated that the same operations of model deployment system 102₁ and authentication system 108₁ as described with reference to process 200 can be performed by other model deployment systems 102₂₋ₙ and other the authentication systems 108₂₋ₖ.

In this regard, in accordance with process 200, at 202 the model deployment system 102₁ applies the object detection model 104₁ to images captured by the model deployment system 102₁ to generate output data. In accordance with the disclosed techniques, the output data can identity whether an input image comprises one or more objects that match one or more defined object criteria for which the object detection model 104₁ is configured to detect, such as being a particular object type, being a particular object type and having a particular color, or the like. For example, in an embodiment in which the model deployment system corresponds to vehicle and the object detection model 104₁ is configured to detect lane markings in video frames captured of the external environment of the vehicle, at 202, the model deployment system can regularly (e.g., according to a defined schedule) or continuously process the video frames by the object detection model to generate output data that identifies respective lane markings as appearing in the video frames. The output data can also identify or indicate the location/position of a matching object in the input image, the contour or outline of the object, and/or the dimensions of the object. For example, as applied to two-dimensional (2D) images defined by a 2D pixel array, the output data can identify or indicate respective pixels or the positions of the respective pixels depicting the object. For instance, as applied to lane markings, the output data can include or correspond to mark-up image data that comprises mark-up data applied to the input image (e.g., as overlay data or otherwise associated with the input image as metadata) that marks respective pixel locations in the input image where lane markings were detected by the object detection model 104₁. In some implementations, the mark-up data can alternatively trace the counters of the lane markings that were detected by the object detection model detection model 104₁.

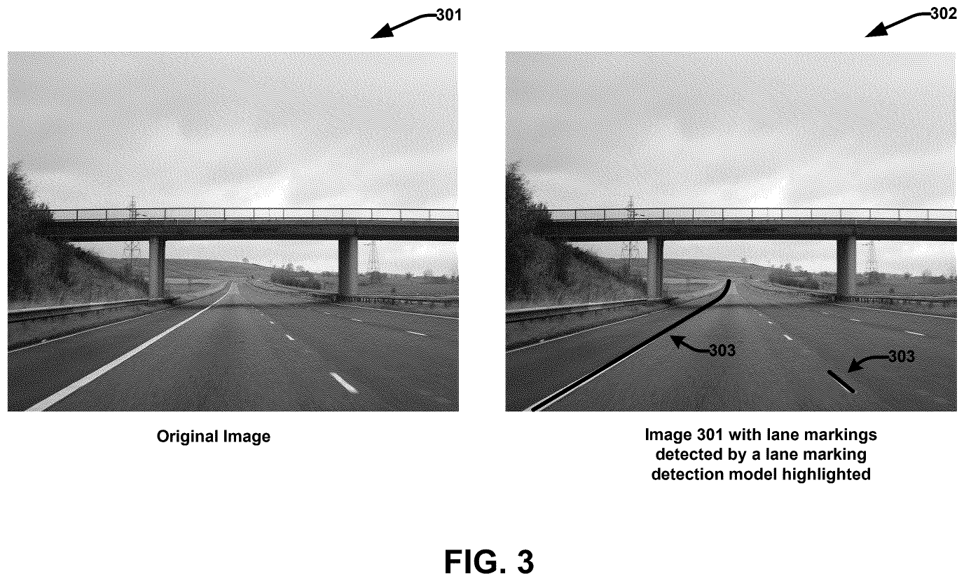

For example, FIG. 3 illustrates example input data (e.g., image 301) and output data capable of being generated by an object detection model configured to detect lane markings in accordance with one or more embodiments described herein. With reference to FIGS. 1-3, image 301 corresponds to an original image (e.g., a single video frame or the like) captured by a camera integrated on or within a vehicle corresponding to model deployment system 102₁ and processed as input to a lane marking detection model corresponding to object detection model 104₁. Image 302 corresponds to image 301 with lane markings detected by the lane marking detection model highlighted with mark-up lines 303. In this example, several dashed white segment lane markings are not highlighted, which indicates that the lane marking detection model either failed to detect these lane markings or detected one or more of them with a regional confidence score below a threshold confidence score sufficient to consider them valid lane markings.

Continuing with process 200, at 206, the federated learning system 106 collects image data 204. To this end, image data 204 can include input images processed by the object detection model as well as the corresponding output data generated for the respective input images identifying any detected objects and their respective positions/locations within the input images. For instance, image data 204 can include original input images, such as original image 301 and/or image 302. In various embodiments, at 206, the image data 204 collected by the federated learning system particularly includes those images processed by the object detection model 104₁ and associated with an error by the object detection model. The detection error can include or correspond to an inability of the model to accurately detect (or detected with an acceptable level of confidence) one or more objects depicted in the images having the defined criterion, such as belonging to a particular object class (e.g., lane markings) or the like. For example, as applied to lane markings, the images collected at 206 can correspond to those images processed at 202 including lane markings that were missed by the object detection model or that were detected with low confidence by the object detection model 104₁, such as image 301 and the like.

In various embodiments, to facilitate identifying images with detection errors or potential detection errors by the object detection model 104₁, the output data generated by object detection model 104₁ can include one or more confidence scores that represent a measure of confidence to which the object detection model 104₁ correctly detected the respective objects in the corresponding input images having the have the defined criterion (e.g., correspond to object of a particular type, such as lane markings, or the like). For example, in some embodiments the confidence scores can include a global confidence score for each image processed by the model that represents an overall measure of confidence in the accuracy of the output data generated by the model. In this regard, the global confidence score can indicate a measure of confidence in how correctly the object detection model identified and localized respective objects in the image satisfying the defined criterion. For instance, if the number of objects detected is greater than one, the global confidence score can account for the accuracy level of detection of all combined objects detected. In some implementations of these embodiments, the federated learning system 106 can collect those images processed at 202 that received a low global confidence score relative to defined criteria, such as being below a threshold global confidence score. In other implementations of these embodiments, the federated learning system 106 can collect those images processed at 202 that received a high global confidence score relative to defined criteria, such as being above a threshold global confidence score.

Additionally, or alternatively, the output data generated by the object detection model 104₁ can include region confidence scores that are associated with different regions of the input image and indicate a measure of confidence that that corresponding regions depict the object having the defined criterion as detected by the object detection model 104₁. For instance, the object detection model can be configured to generate output data that identifies respective regions, parts, portions, etc. (e.g., comprising one or more pixels) in an input image in which the object was detected or potentially detected. The object detection model can further generate region confidence scores for each region. For instance, a region in the input image in which the model is highly confident includes the object (or a portion thereof) can be associated with a high confidence score while another region in the input image in which the model is less confident includes the object can be associated with a lower confidence score. In some implementations of these embodiments, at 206, the images collected for annotation can include images respectively comprising one or more first regions associated with a first confidence score indicative of a high level of confidence that the one or more first regions depict the object as detected by the object detection model (e.g., relative to a threshold confidence level), and one or more second regions associated with a second confidence score indicative of a lower level of confidence relative to the high level of confidence (e.g., relative to a threshold level of confidence), that the one or more second regions depict the object as detected by the object detection model 104₁. With these embodiments, the image data 204 collected at 206 can include the images themselves as well as the region confidence score information.

At 208, the federated learning system 106 converts the images to grid images and provides the grid images (e.g., included in grid image data 210) to the authentication system 108₁. At 212, the authentication system 108₁ employs the grid images for user authentication based on reception of user input selecting respective cells of the grid images depicting an object satisfying the defined criterion for which the object detection model 104₁ is configured to detect. At 214, the authentication system 108₁ provides the grid images back to the annotation system with annotation data associated therewith (e.g., as mark-up data, as metadata, as a separate file, etc.) generated based on the user input, the annotation data identifying the respective cells of the grid images depicting the object of interest (e.g., the object that satisfies the defined criterion for which the object detection model is configured to detect).

In this regard, in accordance with image-based CAPTCHA, the authentication system 108₁ can be configured to present a grid image to a user in association with prompting the user to select respective cells of the grid image depicting the object that matches the defined criterion, such as lane markings in furtherance to the example above. The authentication system can authenticate the user based on reception of user input selecting one or more known cells in the grid image known to depict the object that matches the defined criterion. The authentication system can further generate annotation data identifying the selected cells, including any additional cells other than the known cells depicting the object based on reception of additional user input selecting the additional cells.

To facilitate this end, in some embodiments, as noted above, the images that are collected for annotation at 206 can include images respectively comprising one or more first regions associated with a first confidence score indicative of a high level of confidence that the one or more first regions depict the object as detected by the object detection model 104₁, and one or more second regions associated with a second confidence score indicative of a lower level of confidence relative to the high level of confidence, that the one or more second regions depict the object as detected by the object detection model 104₁. With these embodiments, in association with converting the images to grid images at 208, the federated learning system 106 can generate and/or associate information with the grid images that identifies the respective cells containing the high confidence region or regions (i.e., the one or more first regions). These respective cells of the grid images correspond to the known cells that are used by the authentication system 108₁ to authenticate users as being non-robots. In this regard, the grid image data 210 can include the grid images as well as information identifying the respective known cells.

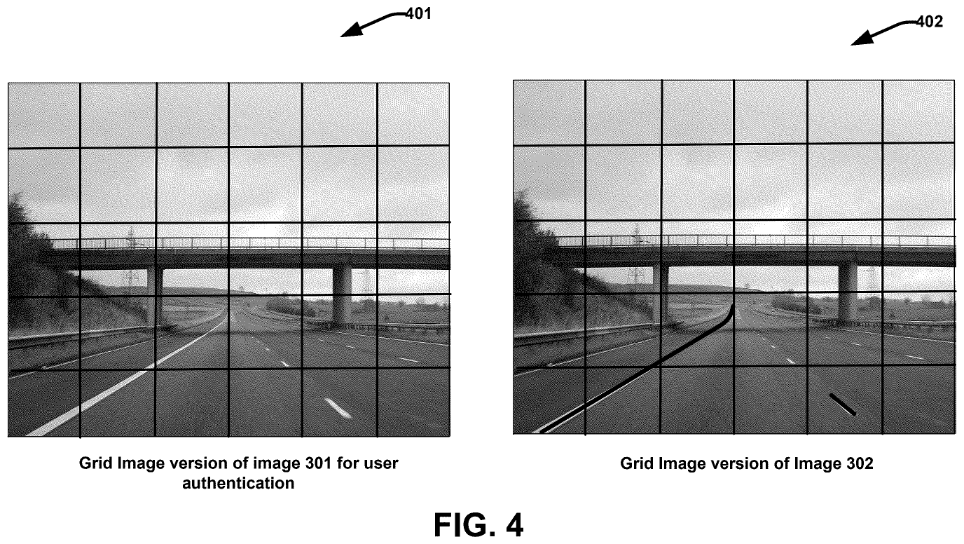

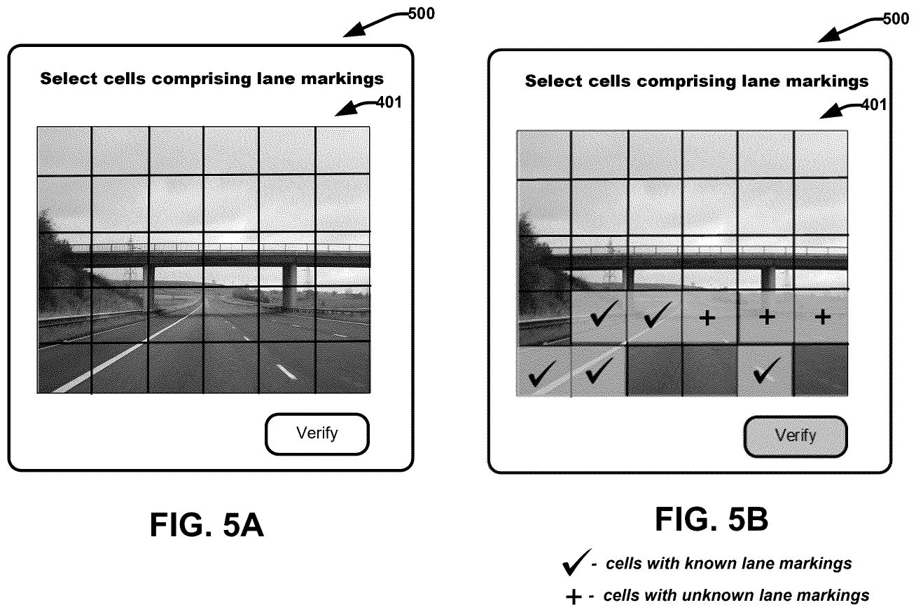

In this regard, with reference briefly to FIGS. 4 and 5A and 5B, FIG. 4 illustrates example grid images in accordance with one or more embodiments described herein. FIGS. 5A and 5B illustrate usage of grid image 401 shown in FIG. 4 to perform an image-based CAPTCHA in accordance with one or more embodiments described herein. FIG. 4 illustrates an example grid image 401 corresponding to a grid image version of image 301. Grid image 401 corresponds to an example grid image that the authentication system 108₁ presents to a user via a prompt 500 shown in FIGS. 5A and 5B in association with performing an image-based CAPTCHA. Grid image 402 provides a corresponding grid image version of image 302 with the mark-up data applied thereto identifying the high confidence lane markings. Grid image 402 is presented in FIG. 4 to provide a visual demonstrative aid of what cells of grid image 401 include known lane markings as detected by the object detection model 104₁ with high confidence. In some cases, the information included in the grid image data identifying the high confidence regions or cell of a corresponding grid image can include or correspond to the mark-up data applied to grid image 402.

As shown in FIG. 4, the grid image 401 (and grid image 402) comprise a plurality of cells arranged in accordance with a 2D grid array (e.g., comprising rows and columns). In this example, the grid image 401 has five rows and six columns (e.g., a 5×6 array). In some embodiments, the grid images generated in accordance with the disclosed techniques can adhere to a fixed array having a fixed number of rows and columns. In other words, all grid images will have the same array configuration (e.g., same number of rows, columns and cells). With these embodiments, the defined number of rows and columns can vary and is not limited to the 5×6 array illustrated in FIG. 4.

In other embodiments, the image division logic (e.g., corresponding to image division component 614) that generates the grid images can tailor the resolution of the grid images based on based on which regions of the image have low confidence scores (thus more cells are created to improve the resolution of the annotation). In this regard, in some embodiments, the image division logic can be configured to tailor the resolution of the cells based on respective sizes and distributions of the one or more low confidence regions. For example, the image division logic can be configured to increase the number of cells as the size and/or distribution of the low confidence regions increases (thus more cells are created to improve the resolution of the annotation).

FIGS. 5A and 5B illustrates an example prompt 500 that the authentication system 108₁ can present in association with performing an image-based CAPTCHA. In this example, the grid image used corresponds to image 401. FIG. 5A illustrates the prompt prior to reception of user input and FIG. 5B illustrates prompt 500 following reception of user input. The user input includes a selection of cells from grid image 401 that depict lane markings. As illustrated in FIG. 5B those cells which were selected by the user are indicated with slightly transparent grey fill. The checkmark and plus sign symbols are overlaid onto the corresponding selected cells in FIG. 5B to indicate those cells corresponding to user selected cells with known lane markings and those user selected cells with unknown lane markings. In practice, the checkmark and plus sign symbols are not displayed. In this example, the user has selected all five of the known cells including known lane markings, along with three additional cells that in fact include lane marking but were not detected, or not detected with sufficient confidence, by the object detection model 104₁. In accordance with this example, the authentication system 108₁ can be configured to authenticate the user based on the user correctly selecting all five of the cells known to include lane markings. The authentication system 108₁ can be further generate annotation data for the grid image 401 that identifies the respective cells selected by the user including lane markings, including the unknown cells alone, or both the unknown cells and the known cells.

In this regard, with reference back to FIG. 2 and process 200 in view of FIGS. 1 and 3-5B, in various embodiments, the annotated grid image data 216 that is provided back to the federated learning system 106 by the authentication system 108₁ at 214 can include or correspond to the original grid images with annotation information associated therewith identifying the respective cells selected by the user as depicting the object of interest. For example, the annotation data can include or correspond to information identifying the unknown cells of image 401 and/or both the unknown and the known cells of image 401.

In some embodiments, the same grid image can be used for multiple CAPTCHA tests and by multiple authentication systems and/or websites. Annotation data received for the same grid image can further be aggregated by the federated learning system 106 in a crowd-sourced manner. Annotation data gathered for a plurality of images for which a particular object detection model is configured to process as input can further be used to regularly or continuously train and/or update the object detection model over time. In other words, the annotation data can be used as ground truth information in association with training the object detection model to detect the respective objects that match the defined criterion in the images and additional images with improved accuracy and/or specificity.

In this regard, continuing with process 200, in various embodiments, the federated learning system 106 can provide the annotated grid image data 216 back to the model deployment system 102₁. At 218, the model deployment system 102₁ can further employ the annotation data (e.g., the information identifying respective cells of the grid image depicting the object of interest) as ground truth information in association with training/updating the object detection model to correctly detect the object satisfying the defined criterion in association with processing the images corresponding to the grid images. For example, in some implementations, the model deployment system can convert the grid images included in the annotated grid image data 216 back to their original form (e.g., without the gridlines) prior to usage thereof for training/updating the object detection model. In other implementations, this conversion can be performed by the federated learning system 106.

In various embodiments, process 200 corresponds to an iterative process that can be performed by the respective systems over time as new images are processed by the object detection model 104₁ and collected for annotation. In this manner, the model deployment system 102₁ can regularly or continuously update the object detection model 104₁ over time. In addition, as noted above with reference to FIG. 1, in various embodiments, the local updates to local versions of the object detection model 104₁ generated by a plurality of different model deployment systems in accordance with process 200 can be received by the federated learning system 106 and employed to generate a globally updated version of the object detection model 104₁.

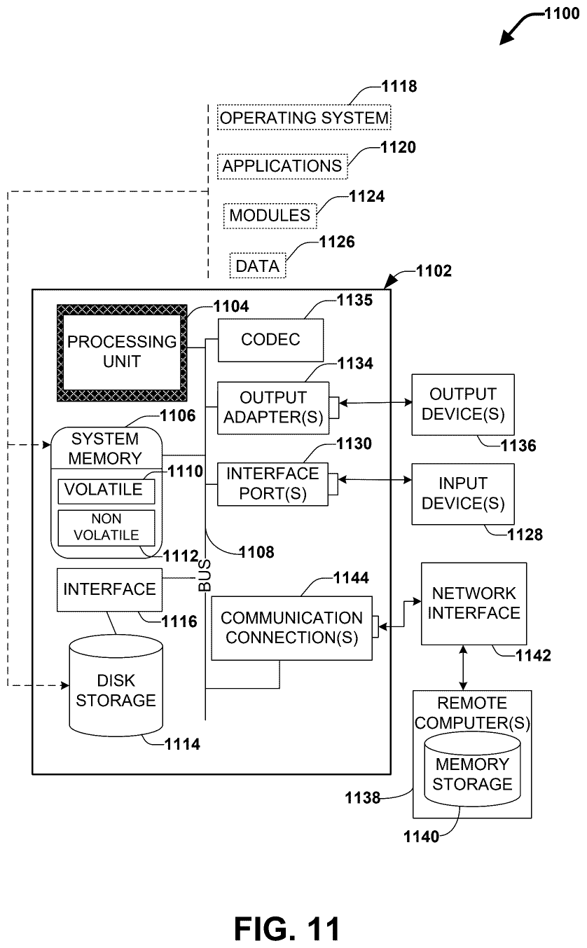

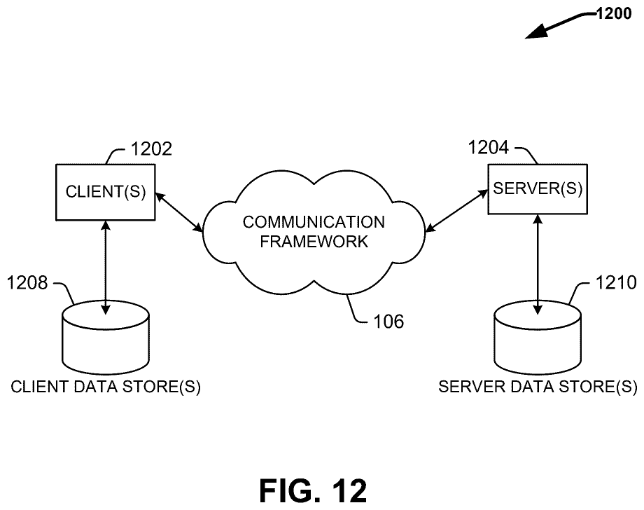

To this end, the one or more model deployment systems 102₁₋ₙ, the federated learning system 106 and the one or more authentication systems 108₁₋ₖ can respectively include or correspond to one or more computing systems comprising one or more computing devices, machines, virtual machines, computer-executable components, datastores, and the like that may communicatively coupled to one another either directly or via one or more wired or wireless communication frameworks. For example, in various embodiments, the federated learning system 106 can correspond to a centralized system that facilitates obtaining and annotating image variants encountered by the respective object detection models 104₁₋ₙ in their respective runtime environments, and providing the annotated image variants back to their corresponding model deployment systems 102₁₋ₙ for continued model updating over time in federated learning manner. In this regard, the one or more model deployment systems 102₁₋ₙ, the federated learning system 106 and the one or more authentication systems 108₁₋ₖ can be communicatively coupled to one another via any suitable wireless communication framework (e.g., the Internet of the like) in accordance with a cloud-based computing architecture, a server-client type architecture or the like, examples of which are described with reference to FIGS. 11 and 12. However, the architecture of system 100 can vary and is not limited to this configuration.

In this regard, embodiments of systems and devices (e.g., the one or more model deployment systems 102₁₋ₙ, the federated learning system 106 and the one or more authentication systems 108₁₋ₖ) described herein can include one or more machine-executable (i.e., computer-executable) components or instructions embodied within one or more machines (e.g., embodied in one or more computer-readable storage media associated with one or more machines). Such components, when executed by the one or more machines (e.g., processors, computers, computing devices, virtual machines, etc.) can cause the one or more machines to perform the operations described. These computer/machine executable components or instructions can be stored in memory associated with the one or more machines. The memory can further be operatively coupled to at least one processor, such that the components can be executed by the at least one processor to perform the operations described. In some embodiments, the memory can include a non-transitory machine-readable medium, comprising the executable components or instructions that, when executed by a processor, facilitate performance of operations described for the respective executable components. Examples of said and memory and processor as well as other suitable computer or computing-based elements, can be found with reference to FIG. 11 (e.g., processing unit 1104 and system memory 1106 respectively), and can be used in connection with implementing one or more of the systems or components shown and described in connection with FIGS. 1-5B, or other figures disclosed herein.

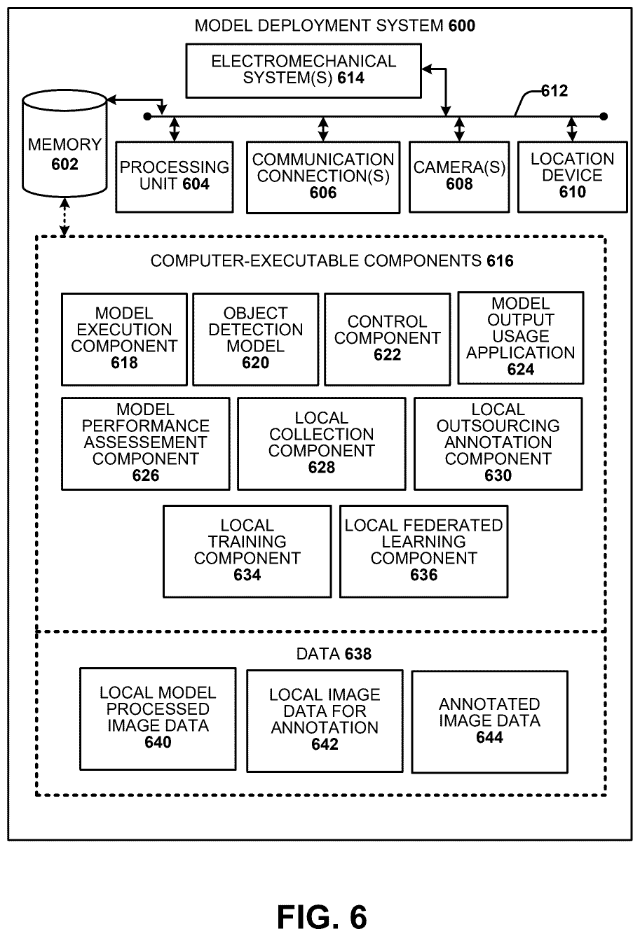

FIG. 6 illustrates a block diagram of an example model deployment system 600 in accordance with one or more embodiments described herein. In various embodiments, each (or one or more) of the model deployment systems 102₁₋ₙ can include or correspond to model deployment system 500 (or vice versa). Repetitive description of like elements employed in respective embodiments is omitted for sake of brevity.

With reference to FIG. 6 in view of FIGS. 1-5B, as noted above with reference to FIG. 1 and system 100, the type of the model deployment systems 102₁₋ₙ can vary and correspond to essentially any type of system configured to employ any type of object detection model to facilitate one or more operations of the system. Some example model deployment systems include vehicles, augmented reality systems, and virtual reality systems. To this end, various examples embodiments of model deployment system 600 are described in the context of the model deployment system 600 being a vehicle. However, it should be apricated that the various feature and functionalities of the model deployment system 600 and the associated computer-executable components 616 can be extended to other types of deployment environments and usage scenarios.

In this regard, model deployment system 600 can include at least one memory 602 that stores computer-executable components 616 and data 638 that facilitate various features and functionalities related to crowdsourcing image annotation using grid image user authentication systems. The model deployment system 600 can includes at least one processor or processing unit 604 that executes the computer-executable components 616 stored in memory 602 to carry out the operations/functions described with respect to the corresponding computer-executable components. Examples of said memory 602, processing unit 604, and other computer system components that can be included with the model deployment system 600 to facilitate the various features and functionalities of system 100 can be found with reference to FIG. 11.

The model deployment system 600 can also include communication connections 606, one or more cameras 608, location device 610, one or more electromechanical systems 614 and a system bus 612 that couples the respective elements of the model deployment system 600 to one another. The communication connections 606 can include or correspond to the hardware and software employed to communicatively couple the model deployment system 600 to other external systems and devices (e.g., other model deployment systems 102₁₋ₙ, the federated learning system 106 and/or the authentication systems 108₁₋ₖ . . . . In this regard, the communication connections 606 can include or correspond to the hardware and software employed by the model deployment system 600 to send data to external systems and devices and receive data from the external systems and devices. Any suitable wired and/or wireless technology can be utilized by the communication connections 606 to enable communication of information between the model deployment system 600 and external systems and devices. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

The one or more cameras 608 can include or correspond to cameras via which image data (e.g., still images and/or video) is captured that is processed by the object detection model 620 (e.g., which corresponds to respective ones of the object detection models 104₁₋ₙ). For example, in embodiments in which the model deployment system 600 corresponds to a vehicle, the one or more cameras 608 can include to a camera that provides a perspective of the external environment of the vehicle and configured to capture video frames of the external environment of the vehicle which are processed by the object detection model 620. In another example, the one or more cameras 608 can include a camera that captures image data providing a perspective of the internal environment of the vehicle, such as a perspective of the driver and/or passengers of the vehicle.

The location device 610 can include or correspond to suitable hardware and software that provides for determining and tracking the location of the model deployment system 600. The location device 610 can employ any suitable location detection technology. For example, the location detection technology can include (but is not limited to), global positioning system (GPS) technology, cellular triangulation technology, Wi-Fi positioning system (WPS) technology, Bluetooth low energy (BLE) beacon technology, radio frequency identification (RFID) technology, internal measurement unit (IMU) technology, ultrawideband (UWB) technology, acoustic-based location detection technology, and combinations thereof.

In some embodiments, the location device 610 can be utilized to determine the location of the model deployment system 600 and corresponding image data captured via the one or more cameras 608. The location information can be utilized to facilitate model updating and federated learning based on geographical location. In this regard, in various embodiments, the particular image variants that are processed by the object detection model 620 can vary based on the location of the model deployment system 600. For instance, as applied to vehicles and the object detection model 620 being used to detect and localize objects in image data captured of the vehicles' external environments, the image data in which the objects appear and the manner in which the objects appear in the image data will vary. For example, as applied to a lane marker detection model, the imagery captured of lane markers can vary significantly for different geographical locations and areas. Hypothetically, an optimal version of a lane marker detection model deployed in all autonomous vehicles around the world would correspond to a model trained on training images depicting every possible image of every existing lane marker in the world and from every possible environment and perspective (while also accounting for different lighting, weather and traffic conditions, among other factors). Although such a model may be achievable over time, to facilitate this end, local versions of the lane marker detection model tailored to account for their local environments (e.g., local geographical areas) can be locally executed and updated by corresponding vehicles to account for image data representative of their local environments.

To facilitate this end, different versions of the lane marker detection model (or the like) tailored to different geographical areas can be trained and updated (e.g., via local training components corresponding to local training component 634) based on annotated training image datasets corresponding to the respective geographical areas. In accordance with the federated learning framework discussed herein, these local versions can be updated local by their corresponding model deployment systems (e.g., via local training components corresponding to local training component 634). The respective model deployment systems can further provide their model updates to the federated learning system 106 which can aggregate the local updates in association with generating a global model that accounts for the different geographical locations. Thus, in association with curating annotated image datasets, the images that are provided by the respective model deployment systems 102₁₋ₙ to the federated learning system 106 can be associated with location information (e.g., as metadata or the like) that indicates the geographical location from which they were captured. For example, images processed by the object detection model 620 and provided by the model deployment system 600 to the federated learning system 106 for annotation can include location information (e.g., as determined via the location device 610) indicating their capture location. Such location information can be maintained with the respective images throughout all aspects of process 200. Accordingly, when providing annotated images back to the respective model deployment systems 102₁₋ₙ for model updating, the federated learning system 106 can select respective sets of annotated images corresponding to the respective geographical locations of the respective model deployment systems 102₁₋ₙ.

The electromechanical systems 614 can include or correspond to various electromechanical systems of the model deployment system 600 that can be controlled and/or otherwise operated by the model deployment system 600 based on and/or using the output of the object detection model 620. For example, in embodiments in which the model deployment system 600 corresponds to a vehicle, the electromechanical systems 614 can include various electromechanical systems of the vehicle that perform or facilitate performing driving operations of the vehicle, such as drivetrain system components and the vehicle's steering system.

To this end, the computer-executable components 616 can include (but are not limited to), model execution component 618, object detection model 620, control component 622, model output usage application 624, model performance assessment component 626, local collection component 628, local outsourcing annotation component 630, local training component 634 and local federated learning component 636. The data 638 can include, but is not limited to, local model processed image data 640, local image data for annotation 642, and annotated image data 644.

In various embodiments, the model execution component 618 applies the object detection model 620 to images captured by the one or more cameras 608 to generate an output. In this regard, as noted above, the object detection model 620 can include or correspond to an object detection model of the object detection models 102₁₋ₙ. To this end, the output can include information regarding presence of an object satisfying defined criterion in an input image and location of the object within the input image (among other information as described above with reference to FIGS. 1-5B). In various embodiments, the local model processed image data 640 can include the input images and the output data generated by the object detection model 620 for the respective input images. In some implementations in which the output of the object detection model 620 includes confidence scores (e.g., global confidence sores and/or region confidence scores), the local model processed image data 640 can also include the confidence sores.

The control component 622 can control various electromechanical systems 614 of the model deployment system 600 based on the output of the object detection model 620. For example, in some embodiments, in which the model deployment system 600 comprises a vehicle and the object detection model 620 corresponds to a lane marking detection model, the control component 622 can control a driving operation and/or a steering operation of the vehicle based on the output of the object detection model 620. In some embodiments, the output of the object detection model 620 can be further processed by a downstream application (e.g., model usage application 624) to generate a corresponding control command for execution by the control component 622. In this regard, the output of the object detection model 620 can indicate whether and where a particular object is detected in image data corresponding to a current environment of the model deployment system 600. How the model deployment system 600 utilizes this information to control operations of the system or perform various responses can vary. For instance, as applied to an autonomous vehicle and a lane marking object detection model, output information defining lane markings of the current road being traveled by the vehicle can be used by an autonomous vehicle navigation program to determine how to steer the vehicle and the control component 622 can control steering accordingly. In accordance with this example, the model output usage application 624 can correspond to the autonomous vehicle navigation program.

In some embodiments, the output of the object detection model 620 can include confidence score information for each output result generated by the model for a given input image. As described above, the confidence score information can include a global confidence score and/or region confidence scores. In some embodiments, the model performance assessment component 626 can be configured to generate the confidence score information as opposed to the object detection model itself. In other embodiments, the model performance assessment component 626 can be configured to assess the performance of the object detection model 620 for a given input image or group of input images (e.g., a group of consecutive video frames) to determine whether the given input image or group of image images correspond to images that would be usefully for further training the model on (and thus collected for annotation) based on other feedback regarding an impact of the model output. For example, as applied to vehicle which use the model output to control or facilitate controlling steering and driving operations of the vehicle in real-time, the other feedback may include feedback indicating an steering error or driving operation has occurred, which could be rooted in poor object detection and location by the object detection model 620. In accordance with this example, the model performance assessment component 626 can flag input/output image data of the object detection model 620 associated with an error by a downstream application (e.g., model output usage application 624) and/or electromechanical system 624 of the model deployment system 600. In some embodiments, this flagged input image data can be collected and included in the local image data for annotation 642.

To this end, in various embodiments, the local collection component 628 can collect the image data processed by the object detection model 620 to be sent to the federated learning system 106 for annotation. This image data can correspond to image data 204 and is represented in FIG. 6 as local image data for annotation 642. As described above, in various embodiments, the image data collected for annotation can include those images processed by the object detection model 620 and associated with a detection error by the object detection model 620 (directly, or indirectly). In this regard, the local image data for annotation 642 can include a select subset of the local model processed image data 640. The local outsourcing annotation component 630 can further provide the local image data for annotation 624 to the federated learning system 106. For example, in some embodiments, the local collection component 628 can be configured to collect images for annotation as they are processed and identified for collection based on their output data satisfying certain criteria attributed to a detection error by the object detection model 620, such as the output data having a global confidence score satisfying certain criteria (e.g., being below a threshold global confidence score) and/or having one or more region confidence scores satisfying certain criteria (e.g., being below a threshold region confidence score), or another measurable indication of a detection error.

The local outsourcing annotation component 630 can be configured to provide batched groupings of the local image data for annotation to the federated learning system 106 in accordance with a defined schedule (e.g., every minute, every hour, every 24 hours, every week, etc.) and/or in response to a defined trigger event (e.g., the amount of collected images reaching a threshold amount, reception of a request from the federated learning system 106, or another trigger event). The local outsourcing annotation component 630 can further be configured to receive and aggregate annotated image data 644 from the federated learning system 106 over time. For example, the annotated image data 644 can include or correspond to the annotated grid image data 218 of process 200 (e.g., with the gridlines removed from the grid images or the grid images otherwise converted back to their original image versions). To this end, the annotated image data 644 includes the ground truth annotation data generated therefore by one or more authentication systems 108₁₋ₖ. In accordance with process 200 the annotated grid image data 218 corresponds to original images captured by the model deployment system and sent out for annotation. It should be appreciated however that the annotated image data 644 received and collected by a particular model deployment system (e.g., model deployment system 600) can include other images provided to the federated learning system 106 by other model deployment systems 102₁₋ₙ. In some embodiments, the annotated image data 644 collected or otherwise received by the local outsourcing annotation component 630 can be filtered to include images captured of a particular geographical area/location associated with the model deployment system 600 so that the local version of the object detection model 620 is tailors and optimizes its learning and performance on image data for the particular geographical area where the model deployment system 600 is used.

The local training data component 634 can further employ the annotated image data 644 to retrain the object detection model 620 in accordance with conventional supervised machine learning techniques. To this end, reference to retraining a ML model, such as object detection model 620, refers to performing additional rounds of training, testing and/or validation of the model using the images of the annotated imaged data 644 as input and the annotation data associated with the respective images (e.g., indicating respective locations and/or bounding boxes of the target object having the defined criterion for which the model is configured to detect) as the ground truth information. To this end, the local training component 634 can employ the annotated image data to retrain and/or update the object detection model 620, which can involve adjusting various parameters and hyperparameters of the model. The local federated learning component 636 can further be configured to provide the federated learning system 600 with updated versions of the object detection model 620 generated by the local training component 634. For example, the local federated learning component 636 can provide the federated learning system 106 with model update information (e.g., a separate update file opposed from a copied version of the object detection model 620) identifying and parameter and hyperparameter adjustments made to the model. As noted above, in various embodiments, the federated learning system 106 can aggregate and employ received model updates from different model deployment systems in association with generating a global version of the object detection model 620 that combines the learning improvements realized and contributed by different local deployment environments and locations.

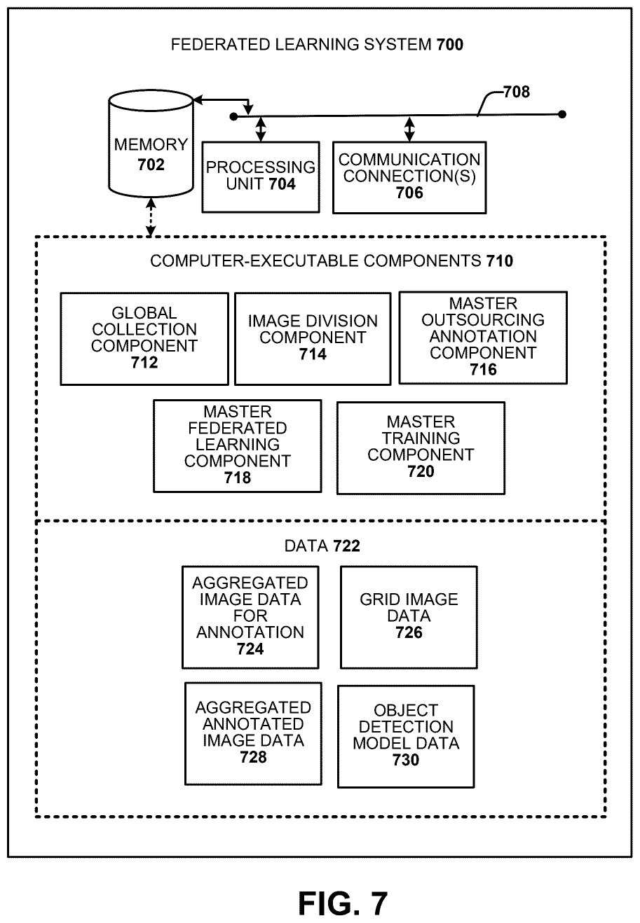

FIG. 7 illustrates a block diagram of an example federated learning system 700 in accordance with one or more embodiments described herein. In various embodiments, federated learning system 700 can include or correspond to federated learning system 106 (or vice versa). Repetitive description of like elements employed in respective embodiments is omitted for sake of brevity.

With reference to FIG. 7 in view of FIGS. 1-6, federated learning system 700 can include at least one memory 702 that stores computer-executable components 710 and data 722 that facilitate various features and functionalities related to crowdsourcing image annotation using grid image user authentication systems. The federated learning system 700 can include at least one processor or processing unit 704 that executes the computer-executable components 710 stored in memory 702 to carry out the operations/functions described with respect to the corresponding computer-executable components. Examples of said memory 702, processing unit 704, and other computer system components that can be included with the federated learning system to facilitate the various features and functionalities of system 100 can be found with reference to FIG. 11. The federated learning system 700 also includes communication connections 706 which can correspond to communication connections 606, and thus repetitive description of the same is omitted for sake of brevity. The federated learning system 700 further incudes a system bus 708 that couples the memory 702, the processing unit 704 and the communication connections 706 to one another.

In various embodiments, the global collection component 712 can correspond to local collection component 628 yet tailored to collect or otherwise receive image data corresponding to image data 204 from a plurality of different model deployment systems 102₁₋ₙ. To this end, image data collected by the global collection component 712 from a plurality of different model deployment systems 102₁₋ₙ can be aggregated and stored by the federated learning system in memory 702 or another memory accessible to the federated learning system 700 and is represented in FIG. 7 as aggregated image data for annotation 724 In some embodiments, the global collection component 712 can cleanse, sort and index the aggregated image data for annotation 724 as a function of time, location (e.g., capture location), and/or system (e.g., of the model deployment system 102₁₋ₙ) from which the respective images are received.

The image division component 714 can convert the images included in the aggregated image data for annotation 726 into grid images comprising a plurality of cells, as described with reference to FIGS. 2-5B. The resulting grid images and the information associated with the grid images indicating respective known cells (known to depict the object of interest) is represented in FIG. 7 as grid image data 726. In some embodiments, the image division component 714 may alternatively be executed by the model deployment system 600.

The master outsourcing annotation component 716 can provide the grid image data 726 and/or different groupings thereof (as new grid image data is received/generated over time), to the one or more authentication systems 108₁₋ₖ. The master outsourcing annotation component 716 can also receive and aggregate annotated grid image data (e.g., corresponding to annotated grid image data 216) from the respective authentication system 108₁₋ₖ. In some embodiments, the image division component 714 can remove the gridlines from the received annotated grid images or otherwise convert the grid images back to their original form yet with the annotation data associated therewith. The grid images and/or the corresponding original versions of the grid images with the annotation data applied thereto are represented in FIG. 7 as aggregated annotated image data 728.

In this regard, in various embodiments, the master outsourcing annotation component 716 provides the grid images to one or more authentication system 108₁₋ₖ that employ the grid images in association with authenticating users based on reception of user input selecting respective cells of the grid images depicting an object having the defined criterion for which the object detection model 620 is configured to detect. The master outsourcing annotation component 716 further receives the grid images from the authentication systems with annotation data associated therewith generated based on the user input, the annotation data identifying the respective cells of the grid images depicting the object having the defined criterion. In some embodiments, the same grid image can be used repeatedly for multiple authentications by the same authentication system or different authentication systems (as directed by the master outsourcing annotation component 716). With these embodiments, feedback from the multiple authentications can be aggregated and crowdsourced to obtain reliable ground truth information for the respective grid images.

The master federated learning component 718 can further provide the aggregated annotated imaged data 728 (or select groupings thereof) to the model deployment systems 102₁₋ₙ which in turn can use the annotated images for locally retraining and updating their versions of the object detection model 620. The master federated learning component 718 can further receive model update files from the respective model deployment systems 102₁₋ₙ and the master training component 720 can employ the model update files in association with generating a global version of the object detection model 620 that accounts for all or some of the local updates. In this regard, the object detection model data 730 can include or correspond to information used by the master training component 720 to generate the global version of the object detection model (e.g., using federated averaging or another federated learning technique), such as the model update files and a latest version of the global object detection model. The master federated learning component 718 can further provide the global version of the object detection model back to the respective model deployment systems 102₁₋ₙ.

Additionally, or alternatively, the master training component 720 can employ the aggregated annotated image data 728 to retrain or update one or more versions of the object detection model 620 (e.g., in a same or similar manner as the local training component 634) and provide model updates to the respective model deployment systems 102₁.

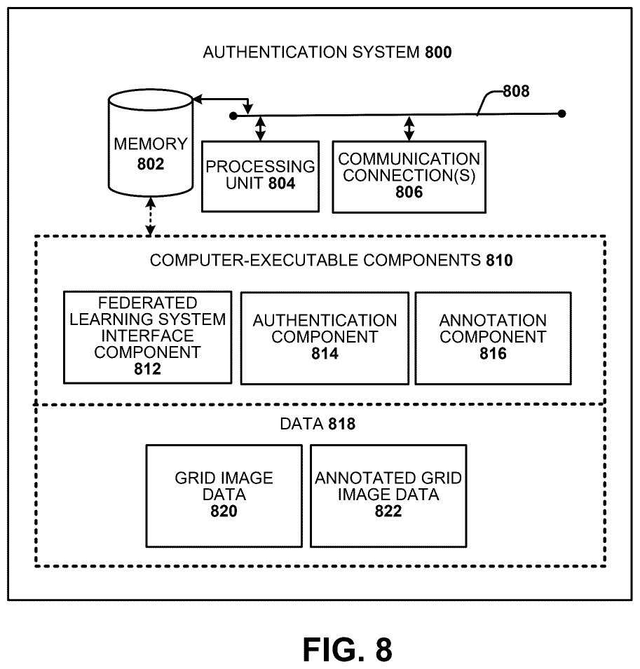

FIG. 8 illustrates a block diagram of an authentication system 800 in accordance with one or more embodiments described herein. In various embodiments, the respective authentication systems 108₁₋ₖ can include or correspond to authentication system 800 (or vice versa). Repetitive description of like elements employed in respective embodiments is omitted for sake of brevity.

With reference to FIG. 8 in view of FIGS. 1-7, authentication system 800 can include at least one memory 802 that stores computer-executable components 810 and data 818 that facilitate various features and functionalities related to crowdsourcing image annotation using grid image user authentication systems. The authentication system 800 can include at least one processor or processing unit 804 that executes the computer-executable components 810 stored in memory 802 to carry out the operations/functions described with respect to the corresponding computer-executable components. Examples of said memory 802, processing unit 804, and other computer system components that can be included with the federated learning system to facilitate the various features and functionalities of system 100 can be found with reference to FIG. 11. The authentication system 800 also includes communication connections 806 (which can correspond to communication connections 606, and thus repetitive description of the same is omitted for sake of brevity). The authentication system 800 further incudes a system bus 808 that couples the memory 802, the processing unit 804 and the communication connections 806 to one another.

In various embodiments, the computer-executable components 810 can include federated learning system interface component 812, authentication component 814 and annotation component 816, and data 818 can include grid image data 820 and annotated grid image data 822.

The federated learning system interface component 812 can facilitate interfacing the authentication system 800 with the federated learning system 700 (and vice versa). For example, in some embodiments, the federated learning system interface component 812 can include or correspond to an application program interface (API) of the authentication system 800. To this end, the federated learning system interface component 812 can receive grid image data corresponding to grid image data 210 from the federated learning system 700. The received grid image data can be temporarily stored in memory accessible to the authentication system (e.g., in memory 802 and stored as grid image data 820). In some embodiments, the authentication system can store respective grid images included in the grid image data for a limited duration and/or until they have received annotation data, and/or have received a sufficient amount of annotation data following usage thereof for multiple authentications (e.g., in accordance with defined authentication usage preference or the like). Those grid images with annotation data applied thereto (e.g., annotated grid image data 822) can also be stored and aggregated by the authentication system 800 prior to sending back to the federated learning system 700.

The authentication component 814 can employ the grid images (e.g., included in the grid image data 820) to authenticate users in accordance with the techniques described herein. In this regard, the authentication component 814 can generate and perform grid-image based CAPTCHAs using the grid images. The authentication component 814 can further authenticate users based on reception of user input selecting respective known cells of the grid images known to include the object of interest. The annotation component 816 can further generate annotation data for the grid images identifying the known cells and any additional (e.g. unknown) cells selected by the respective users. In some embodiments, the annotated grid image data 822 can aggregate annotation data received for the same grid image in association with usage thereof for multiple annotations.

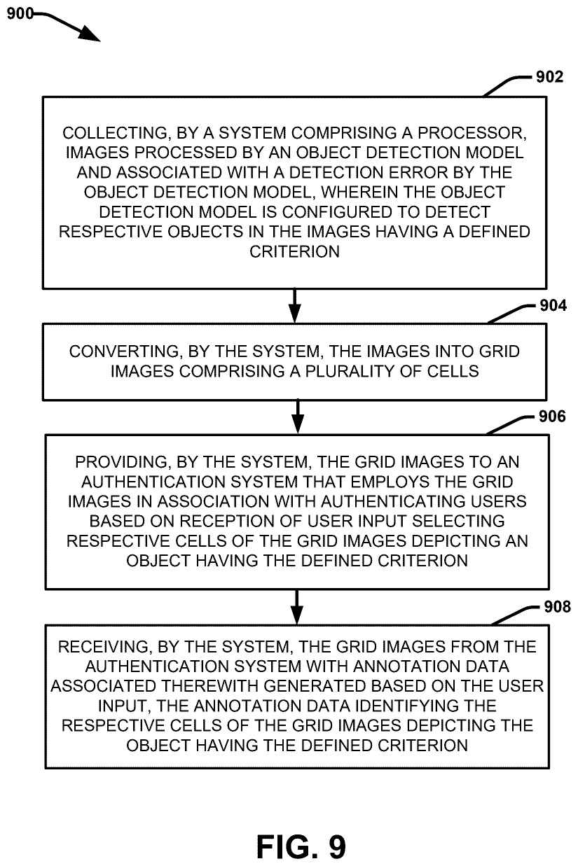

FIG. 9 illustrates a block flow diagram of an example, non-limiting computer-implemented method 900 for crowdsourcing image annotation using grid image user authentication systems, in accordance with one or more embodiments described herein. With reference to FIG. 9 in view of FIGS. 1-8, in various embodiments, method 900 corresponds to an example method that can be performed by one or more of the model deployment systems 102₁₋ₙ and/or the federated learning system 106. Repetitive description of like elements employed in respective embodiments is omitted for sake of brevity.

At 902, method 900 comprises collecting, by a system comprising a processor, images processed by an object detection model and associated with a detection error by the object detection model, wherein the object detection model is configured to detect respective objects in the images having a defined criterion. At 904, method 900 comprises converting, by the system, the images into grid images comprising a plurality of cells. At 906, method 900 comprises providing, by the system, the grid images to an authentication system that employs the grid images in association with authenticating users based on reception of user input selecting respective cells of the grid images depicting an object having the defined criterion. At 908, method 900 comprises receiving, by the system, the grid images from the authentication system with annotation data associated therewith generated based on the user input, the annotation data identifying the respective cells of the grid images depicting the object having the defined criterion.

In some embodiments, method 900 can further comprise employing, by the system, the annotation data as ground truth information in association with training the object detection model to detect the respective objects having the defined criterion in the images and additional images with a reduction of the detection error.

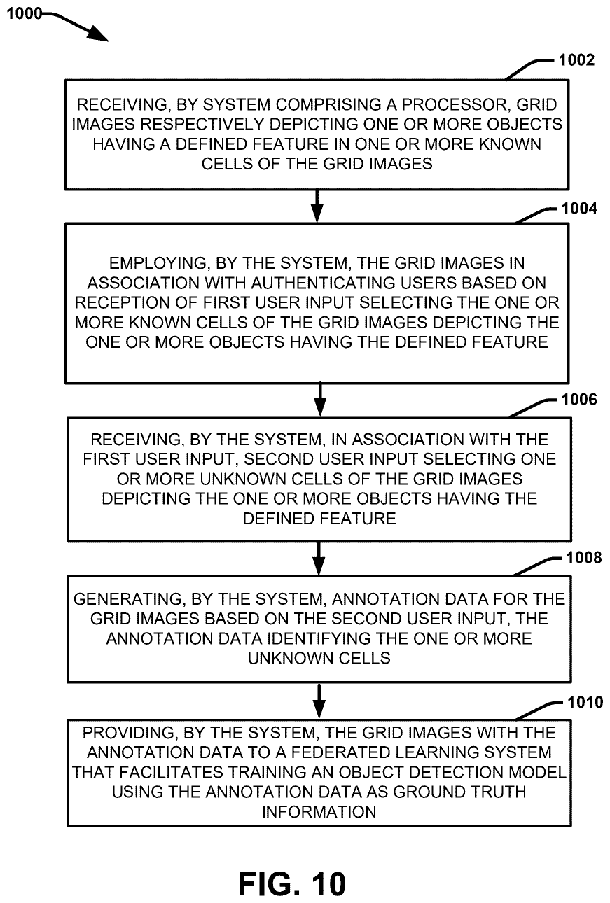

FIG. 10 illustrates a block flow diagram of an example, non-limiting computer-implemented method 1000 for crowdsourcing image annotation using grid image user authentication systems, in accordance with one or more embodiments described herein. With reference to FIG. 10 in view of FIGS. 1-9, in various embodiments, method 1000 corresponds to an example method that can be performed by one or more of the authentication systems 108₁₋ₖ. Repetitive description of like elements employed in respective embodiments is omitted for sake of brevity.

At 1002, method 1000 comprises receiving, by a system comprising a processor, grid images respectively depicting one or more objects having a defined feature in one or more known cells of the grid images (e.g., object being lane markings for instance). At 1004, method 1000 comprises employing, by the system, the grid images in association with authenticating users based on reception of first user input selecting the one or more known cells of the grid images depicting the one or more objects having the defined feature. At 1006, method 1000 comprises receiving, by the system, in association with the first user input, second user input selecting one or more unknown cells of the grid images depicting the one or more objects having the defined feature. At 1008, method 100 comprises generating, by the system, annotation data for the grid images based on the second user input, the annotation data identifying the one or more unknown cells. At 1010, method 100 comprises providing, by the system, the grid images with the annotation data to a federated learning system that facilitates training an object detection model using the annotation data as ground truth information.

One or more embodiments can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. To this end, a computer readable storage medium, a machine-readable storage medium, or the like as used herein can include a non-transitory computer readable storage medium, a non-transitory machine-readable storage medium, and the like.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It can be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In connection with FIG. 11, the systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which can be explicitly illustrated herein.

With reference to FIG. 11, an example environment 1100 for implementing various aspects of the claimed subject matter includes a computer 1102. The computer 1102 includes a processing unit 1104, a system memory 1106, a codec 1135, and a system bus 1108. The system bus 1108 couples system components including, but not limited to, the system memory 1106 to the processing unit 1104. The processing unit 1104 can be any of various available processors. Dual microprocessors and other multiprocessor architectures also can be employed as the processing unit 1104.

The system bus 1108 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1384), and Small Computer Systems Interface (SCSI).

The system memory 1106 includes volatile memory 1111 and non-volatile memory 1112, which can employ one or more of the disclosed memory architectures, in various embodiments. The basic input/output system (BIOS), containing the basic routines to transfer information between elements within the computer 1102, such as during start-up, is stored in non-volatile memory 1112. In addition, according to present innovations, codec 1135 can include at least one of an encoder or decoder, wherein the at least one of an encoder or decoder can consist of hardware, software, or a combination of hardware and software. Although, codec 1135 is depicted as a separate component, codec 1135 can be contained within non-volatile memory 1112. By way of illustration, and not limitation, non-volatile memory 1112 can include read only memory (ROM), programmable ROM (PROM), electrically programmable ROM (EPROM), electrically erasable programmable ROM (EEPROM), Flash memory, 3D Flash memory, or resistive memory such as resistive random access memory (RRAM). Non-volatile memory 1112 can employ one or more of the disclosed memory devices, in at least some embodiments. Moreover, non-volatile memory 1112 can be computer memory (e.g., physically integrated with computer 1102 or a mainboard thereof), or removable memory. Examples of suitable removable memory with which disclosed embodiments can be implemented can include a secure digital (SD) card, a compact Flash (CF) card, a universal serial bus (USB) memory stick, or the like. Volatile memory 1111 includes random access memory (RAM), which acts as external cache memory, and can also employ one or more disclosed memory devices in various embodiments. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM) and so forth.

Computer 1102 can also include removable/non-removable, volatile/non-volatile computer storage medium. FIG. 11 illustrates, for example, disk storage 1114. Disk storage 1114 includes, but is not limited to, devices like a magnetic disk drive, solid state disk (SSD), flash memory card, or memory stick. In addition, disk storage 1114 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1114 to the system bus 1108, a removable or non-removable interface is typically used, such as interface 1116. It is appreciated that disk storage 1114 can store information related to a user. Such information might be stored at or provided to a server or to an application running on a user device. In one embodiment, the user can be notified (e.g., by way of output device(s) 1136) of the types of information that are stored to disk storage 1114 or transmitted to the server or application. The user can be provided the opportunity to opt-in or opt-out of having such information collected or shared with the server or application (e.g., by way of input from input device(s) 1128).

It is to be appreciated that FIG. 11 describes software that acts as an intermediary between users and the basic computer resources described in the suitable operating environment 1100. Such software includes an operating system 1111. Operating system 1111, which can be stored on disk storage 1114, acts to control and allocate resources of the computer 1102. Applications 1120 take advantage of the management of resources by operating system 1111 through program modules 1124, and program data 1126, such as the boot/shutdown transaction table and the like, stored either in system memory 1106 or on disk storage 1114. It is to be appreciated that the claimed subject matter can be implemented with various operating systems or combinations of operating systems.

A user enters commands or information into the computer 1102 through input device(s) 1128. Input devices 1128 include, but are not limited to, a pointing device such as a mouse, trackball, stylus, touch pad, touchscreen, keyboard, microphone, joystick, game pad, satellite dish, scanner, TV tuner card, digital camera, digital video camera, web camera, and the like. These and other input devices connect to the processing unit 1104 through the system bus 1108 via interface port(s) 1130. Interface port(s) 1130 include, for example, a serial port, a parallel port, a game port, and a universal serial bus (USB). Output device(s) 1136 use some of the same type of ports as input device(s) 1128. Thus, for example, a USB port can be used to provide input to computer 1102 and to output information from computer 1102 to an output device 1136. Output adapter 1134 is provided to illustrate that there are some output devices 1136 like monitors/displays, speakers, and printers, among other output devices 1136, which require special adapters. The output adapters 1134 include, by way of illustration and not limitation, video and sound cards that provide a means of connection between the output device 1136 and the system bus 1108. It should be noted that other devices or systems of devices provide both input and output capabilities such as remote computer(s) 1138.

Computer 1102 can operate in a networked environment using logical connections to one or more remote computers, such as remote computer(s) 1138. The remote computer(s) 1138 can be a personal computer, an onboard vehicle computer, a communication device (e.g., a mobile phone, a smartphone, a smartwatch, a wearable device, etc.), a server, a router, a network PC, a workstation, a microprocessor based appliance, a peer device, a smart phone, a tablet, or other network node, and typically includes many of the elements described relative to computer 1102. For purposes of brevity, only a memory storage device 1140 is illustrated with remote computer(s) 1138. Remote computer(s) 1138 is logically connected to computer 1102 through a network interface 1142 and then connected via communication connection(s) 1144. Network interface 1142 encompasses wire or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1144 refers to the hardware/software employed to connect the network interface 1142 to the bus 1108. While communication connection 1144 is shown for illustrative clarity inside computer 1102, it can also be external to computer 1102. The hardware/software necessary for connection to the network interface 1142 includes, for exemplary purposes only, internal and external technologies such as, modems including regular telephone grade modems, cable modems and DSL modems, ISDN adapters, and wired and wireless Ethernet cards, hubs, and routers.

It is to be noted that aspects or features of this disclosure can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

Referring now to FIG. 12, there is illustrated a schematic block diagram of a computing environment 1200 in accordance with this specification. The system 1200 includes one or more client(s) 1202, (e.g., computers, smart phones, tablets, cameras, PDA's). The client(s) 1202 can be hardware and/or software (e.g., threads, processes, computing devices). The client(s) 1202 can house cookie(s) and/or associated contextual information by employing the specification, for example.

The system 1200 also includes one or more server(s) 1204. The server(s) 1204 can also be hardware or hardware in combination with software (e.g., threads, processes, computing devices). The servers 1204 can house threads to perform transformations of media items by employing aspects of this disclosure, for example. One possible communication between a client 1202 and a server 1204 can be in the form of a data packet adapted to be transmitted between two or more computer processes wherein data packets may include coded analyzed headspaces and/or input. The data packet can include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204. Further, the client(s) 1202 can be operatively connected to one or more server data store(s) 1210.

In one exemplary implementation, a client 1202 can transfer an encoded file, (e.g., encoded media item), to server 1204. Server 1204 can store the file, decode the file, or transmit the file to another client 1202. It is noted that a client 1202 can also transfer uncompressed file to a server 1204 and server 1204 can compress the file and/or transform the file in accordance with this disclosure. Likewise, server 1204 can encode information and transmit the information via communication framework 1206 to one or more clients 1202.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:

1. A system, comprising:
a memory that stores computer executable components; and
a processor that executes the computer executable components stored in the memory, wherein the computer executable components comprise:
   a collection component that collects images processed by an object detection model and associated with a detection error by the object detection model, wherein the object detection model is configured to detect respective objects in the images that satisfy a defined criterion;
   an image division component that converts the images into grid images comprising a plurality of cells; and
   an outsourcing annotation component that provides the grid images to an authentication system that employs the grid images in association with authenticating users based on reception of user input selecting respective cells of the grid images depicting an object having the defined criterion, and receives the grid images from the authentication system with annotation data associated therewith generated based on the user input, the annotation data identifying the respective cells of the grid images depicting the object having the defined criterion.

2. The system of clause 1, wherein the computer-executable components comprise:
a training component that employs the annotation data as ground truth information in association with training the object detection model to detect the respective objects having the defined criterion in the images and additional images with a reduction of the detection error.

3. The system of clause 1, wherein the detection error comprises a confidence score below a threshold confidence score, wherein the confidence score represents a measure of confidence to which the object detection model correctly detected the respective objects in the images having the defined criterion.

4. The system of clause 1, wherein the collection component collects the images based on the images respectively comprising one or more first regions associated with a first confidence score indicative of a high level of confidence that the one or more first regions depict the object as detected by the object detection model, and based on the images comprising one or more second regions associated with a second confidence score indicative of a lower level of confidence relative to the high level of confidence, that the one or more second regions depict the object as detected by the object detection model.

5. The system of clause 4, wherein the authentication system employs the grid images in association with authenticating the users based on reception of the user input selecting one or more first cells of the grid images comprising the one or more first regions.

6. The system of clause 5, wherein the authentication system generates the annotation data based on reception of the user input selecting one or more second cells of the grid images excluding the one or more first regions.

7. The system of clause 4, wherein the image division component tailors respective resolutions of the cells of the grid images based on respective sizes and distributions of the one or more second regions.

8. The system of clause 1, wherein the images comprise vehicle images captured via one or more cameras integrated on or within a vehicle.

9. The system of clause 8, wherein the defined criterion comprises a lane marker classification.

10. The system of clause 8, wherein processing of the images by the object detection model is executed by an onboard computer system of the vehicle in association with usage of an output of the object detection model to control a driving operation of the vehicle by an advanced driver assistance system of the vehicle.

11. The system of clause 1, wherein the system comprises an onboard computer system located on or within a vehicle.

12. The system of clause 2, wherein the system comprises an onboard computer system located on or within a vehicle, wherein the images comprise vehicle images captured via one or more cameras integrated on or within a vehicle, and wherein the computer-executable components further comprise:
a model execution component that applies the object detection model to the vehicle images; and
a control component that controls a driving operation of the vehicle based on an output of the object detection model.

The system of clause 1 above with any set of combinations of the systems of clauses 2-12 above.

13. A method, comprising:
collecting, by a system comprising a processor, images processed by an object detection model and associated with a detection error by the object detection model, wherein the object detection model is configured to detect respective objects in the images having a defined criterion;
converting, by the system, the images into grid images comprising a plurality of cells;
providing, by the system, the grid images to an authentication system that employs the grid images in association with authenticating users based on reception of user input selecting respective cells of the grid images depicting an object having the defined criterion; and
receiving, by the system, the grid images from the authentication system with annotation data associated therewith generated based on the user input, the annotation data identifying the respective cells of the grid images depicting the object having the defined criterion.

14. The method of clause 13, further comprising:
employing, by the system, the annotation data as ground truth information in association with training the object detection model to detect the respective objects having the defined criterion in the images and additional images with a reduction of the detection error.

15. The method of clause 13, wherein the detection error comprises a confidence score below a threshold confidence score, wherein the confidence score represents a measure of confidence to which the object detection model correctly detected the respective objects in the images having the defined criterion.

16. The method of clause 13, wherein the collecting the images is based on the images respectively comprising one or more first regions associated with a first confidence score indicative of a high level of confidence that the one or more first regions depict the object as detected by the object detection model, and based on the images comprising one or more second regions associated with a second confidence score indicative of a lower level of confidence, relative to the high level of confidence, that the one or more second regions depict the object as detected by the object detection model.

17. The method of clause 16, wherein the authentication system employs the grid images in association with authenticating the users based on reception of the user input selecting one or more first cells of the grid images comprising the one or more first regions, and wherein the authentication system generates the annotation data based on reception of the user input selecting one or more second cells of the grid images excluding the one or more first regions.

18. The method of clause 16, wherein the converting comprises tailoring respective resolutions of the cells of the grid images based on respective sizes and distributions of the one or more second regions.

The method of clause 13 above with any set of combinations of the methods of clauses 14-18 above.

19. A non-transitory machine-readable storage medium, comprising executable instructions that, when executed by a processor onboard a vehicle, facilitate performance of operations, comprising:
collecting images respectively depicting one or more objects associated with a confidence score below a threshold confidence score, wherein the confidence score represents a measure of confidence to which an object detection model correctly classified a defined feature of the one or more objects in association with processing the images;
converting the images into grid images comprising a plurality of cells;
providing the grid images to an authentication system that employs the grid images in association with authenticating users based on reception of user input selecting respective cells of the grid images depicting the one or more objects with the defined feature; and
receiving the grid images from the authentication system with annotation data associated therewith generated based on the user input, the annotation data identifying the one or more objects comprising the defined feature.

20. The non-transitory machine-readable storage medium of clause 19, wherein the operations further comprise:
employing the annotation data as ground truth information in association with training the object detection model to correctly classify the one or more objects with the defined feature in association with processing the images.

What is claimed is:

1. A system, comprising:
a memory that stores computer executable components; and
a processor that executes the computer executable components stored in the memory, wherein the computer executable components comprise:
a collection component that collects images processed by an object detection model and associated with a detection error by the object detection model, wherein the object detection model is configured to detect respective objects in the images that satisfy a defined criterion;
an image division component that converts the images into grid images comprising a plurality of cells; and
an outsourcing annotation component that provides the grid images to an authentication system that employs the grid images in association with authenticating users based on reception of user input selecting respective cells of the grid images depicting an object having the defined criterion, and receives the grid images from the authentication system with annotation data associated therewith generated based on the user input, the annotation data identifying the respective cells of the grid images depicting the object having the defined criterion.

2. The system of claim 1, wherein the computer-executable components comprise:
a training component that employs the annotation data as ground truth information in association with training the object detection model to detect the respective objects having the defined criterion in the images and additional images with a reduction of the detection error.

3. The system of claim 1, wherein the detection error comprises a confidence score below a threshold confidence score, wherein the confidence score represents a measure of confidence to which the object detection model correctly detected the respective objects in the images having the defined criterion.

4. The system of claim 1, wherein the collection component collects the images based on the images respectively comprising one or more first regions associated with a first confidence score indicative of a high level of confidence that the one or more first regions depict the object as detected by the object detection model, and based on the images comprising one or more second regions associated with a second confidence score indicative of a lower level of confidence relative to the high level of confidence, that the one or more second regions depict the object as detected by the object detection model.

5. The system of claim 4, wherein the authentication system employs the grid images in association with authenticating the users based on reception of the user input selecting one or more first cells of the grid images comprising the one or more first regions.

6. The system of claim 5, wherein the authentication system generates the annotation data based on reception of the user input selecting one or more second cells of the grid images excluding the one or more first regions.

7. The system of claim 4, wherein the image division component tailors respective resolutions of the cells of the grid images based on respective sizes and distributions of the one or more second regions.

8. The system of claim 1, wherein the images comprise vehicle images captured via one or more cameras integrated on or within a vehicle.

9. The system of claim 8, wherein the defined criterion comprises a lane marker classification.

10. The system of claim 8, wherein processing of the images by the object detection model is executed by an onboard computer system of the vehicle in association with usage of an output of the object detection model to control a driving operation of the vehicle by an advanced driver assistance system of the vehicle.

11. The system of claim 1, wherein the system comprises an onboard computer system located on or within a vehicle.

12. The system of claim 2, wherein the system comprises an onboard computer system located on or within a vehicle, wherein the images comprise vehicle images captured via one or more cameras integrated on or within a vehicle, and wherein the computer-executable components further comprise:
a model execution component that applies the object detection model to the vehicle images; and
a control component that controls a driving operation of the vehicle based on an output of the object detection model.

13. A method, comprising:
collecting, by a system comprising a processor, images processed by an object detection model and associated with a detection error by the object detection model, wherein the object detection model is configured to detect respective objects in the images having a defined criterion;
converting, by the system, the images into grid images comprising a plurality of cells;
providing, by the system, the grid images to an authentication system that employs the grid images in association with authenticating users based on reception of user input selecting respective cells of the grid images depicting an object having the defined criterion; and
receiving, by the system, the grid images from the authentication system with annotation data associated therewith generated based on the user input, the annotation data identifying the respective cells of the grid images depicting the object having the defined criterion.

14. The method of claim 13, further comprising:
employing, by the system, the annotation data as ground truth information in association with training the object detection model to detect the respective objects having the defined criterion in the images and additional images with a reduction of the detection error.

15. The method of claim 13, wherein the detection error comprises a confidence score below a threshold confidence score, wherein the confidence score represents a measure of confidence to which the object detection model correctly detected the respective objects in the images having the defined criterion.

16. The method of claim 13, wherein the collecting the images is based on the images respectively comprising one or more first regions associated with a first confidence score indicative of a high level of confidence that the one or more first regions depict the object as detected by the object detection model, and based on the images comprising one or more second regions associated with a second confidence score indicative of a lower level of confidence, relative to the high level of confidence, that the one or more second regions depict the object as detected by the object detection model.

17. The method of claim 16, wherein the authentication system employs the grid images in association with authenticating the users based on reception of the user input selecting one or more first cells of the grid images comprising the one or more first regions, and wherein the authentication system generates the annotation data based on reception of the user input selecting one or more second cells of the grid images excluding the one or more first regions.

18. The method of claim 16, wherein the converting comprises tailoring respective resolutions of the cells of the grid images based on respective sizes and distributions of the one or more second regions.

19. A non-transitory machine-readable storage medium, comprising executable instructions that, when executed by a processor, facilitate performance of operations, comprising:
collecting images respectively depicting one or more objects associated with a confidence score below a threshold confidence score, wherein the confidence score represents a measure of confidence to which an object detection model correctly classified a defined feature of the one or more objects in association with processing the images;
converting the images into grid images comprising a plurality of cells;
providing the grid images to an authentication system that employs the grid images in association with authenticating users based on reception of user input selecting respective cells of the grid images depicting the one or more objects with the defined feature; and
receiving the grid images from the authentication system with annotation data associated therewith generated based on the user input, the annotation data identifying the one or more objects comprising the defined feature.

20. The non-transitory machine-readable storage medium of claim 19, wherein the operations further comprise:
employing the annotation data as ground truth information in association with training the object detection model to correctly classify the one or more objects with the defined feature in association with processing the images.
